(19) United States
(12) Patent Application Publication
(10) Pub. No.: US 2002/0182746 A1
(43) Pub. Date: Dec. 5, 2002

(54) Method and device for sample introduction of volatile analytes

(76) Inventors: Zoltan Mester, Vanier (CA); Ralph Sturgeon, Orleans (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 09/867,663

(22) Filed: May 31, 2001

(51) Int. Cl. G01N 1/38

(52) U.S. Cl. 436/178; 436/180; 436/181; 436/173; 422/69; 422/88; 422/100; 422/101; 422/103

(57) ABSTRACT

The present invention relates to a simple thermal desorption gas introduction interface for sample introduction of volatile analytes into an atomic spectroscopic detector. An injector is connected to the atomic spectroscopic detector via a first port. The injector further comprises a sealed second port for inserting the volatile analyte bound to an extraction phase. A heating block surrounding the injector heats the injector to a predetermined temperature and keeps it substantially at the predetermined temperature. A carrier gas flow of inert gas is provided into the injector through a third port of the injector located in proximity to the second port. An auxiliary gas flow of inert gas is provided via forth port located between the third port and the atomic spectroscopic detector. The volatile analyte bound to an extraction phase is inserted into the injector, wherein the extraction phase is inserted through the seal of the second port for sealed exposure within the injector. The volatile analyte is then rapidly thermally desorbed from the extraction phase through application of the heat and provision of the carrier gas flow and transported to the atomic spectroscopic detector in a gas flow comprising the carrier gas flow and the auxiliary gas flow.

### FIELD OF THE INVENTION

The invention relates generally to an interface for use with a spectroscopic detector and, in particular to a simple thermal desorption gas introduction interface for sample introduction of volatile analytes into an atomic or organic mass spectroscopic detector.

### BACKGROUND OF THE INVENTION

Organometallic species are found in our environment either because they are naturally found there or because they have been introduced by anthropogenic contributions. In general, these species are more toxic than their inorganic salts—except organoarsenic compounds—particularly because of their combined hydrophobic and lipophilic characteristics making them capable of entering biological cycles with detrimental consequences. For instance, methylmercury has attracted considerable attention from the scientific community due to its extreme toxicity. Typically, methylmercury enters the environment by direct release through abiotic processes or via methylation of inorganic mercury in biological systems. The latter process provides an alternative route for the bioaccumulation of methylmercury throughout many food chains. The resulting biomagnification of methylmercury has dramatic consequences for top predators such as humans. The best known example in recent history is the Minimata catastrophe in which over one hundred people died and many more suffered permanent disability from high level exposure. Therefore, the need to perform organometallic speciation studies has become a topic of growing importance over the last years.

Generally, in analysis of samples such as, for example, samples of soil, tissue, water, fly ash, for trace residues of analytes of interest from matrices it is common to extract and then enrich or concentrate the content of the analytes in order to achieve better detection capability. Commonly used enrichment methods are: simple concentration of a dilute solution containing organic analytes by reducing the content of the solvents; liquid-liquid or liquid-solid extraction, generally followed by concentration of the extracts; gas-solid extraction or purge and trap methods, generally followed by desorption of analytes from solids or traps; leeching/extracting of analytes from solid samples with an organic solvent; and supercritical fluid extractions. However, these processes have one or more of numerous problems such as being difficult and time consuming, needing large sample volumes, having low detection power, or using organic solvents which present problems of disposability, toxicity and the like. Some of these common methods are described in:

M. Garcia, M. L. F. Sanchez, J. E. S. Uria and A. Sanz-Medel, Mikrochim. Acta, 1996, 122, 157;

Alli, R. Jaffe and R. Jones, J. High Resolut. Chromatogr., 1994, 17, 745;

E. M. S. Brito and J. R. D. Guimares, Appl. Organomet. Chem., 1999, 19, 487;

H. Hintelmann, Can. J. Anal. Sci. Spectrosc., 1998, 46, 182;

E. Bulska, D. C. Baxter and B. Allard, Anal Chim. Acta, 1999, 394, 259; and,

G. Hu, X. Wrang, Y. Wrang, X. Chen and L. Jia, Anal. Lett., 1997, 30, 2579,

which are incorporated herein by reference.

Therefore, a solid phase microextraction (SPME) process was recently developed by Janusz Pawliszyn to eliminate solvent use. The SPME process is disclosed, for example in International Patent (PCT) Publication WO 91/15745 of J. Pawliszyn, published Oct. 17, 1991, which is incorporated herein by reference. In the SPME process a coated or uncoated fiber housed within a needle of a syringe is brought into contact with components/analytes in a fluid carrier or headspace above the carrier for a sufficient period of time for extraction of the analytes to occur onto the fiber or coated fiber. Subsequently the fiber is removed from the carrier or headspace above the carrier. The analytes are desorbed from the fiber generally by thermal desorption into an analytical instrument such as a gas chromatograph (GC) for detection and quantification of the analytes. SPME has been shown to be a very useful sample preparation technique for a large variety of analytes. Detailed information about the SPME process and its applications are described in the following references:

Z. Mester, R. Sturgeon and J. Pawliszyn, Spectrochim. Acta, Part B, 2001, 56, 233;

Z. Mester, J. Lam, R. Sturgeon and J. Pawliszyn, J. Anal. At. Spectrom., 2000, 15, 837;

M. Guidotti and M. Vitali, HRC-J. High Resolut. Chormatogr., 1998, 21, 665;

L. Moens, T. DeSmaele, R. Dams, P. VandenBroeck and P. Sandra, Anal. Chem., 1997, 69, 1604;

X. Yu, H. Yuan, T. Górecki and J. Pawliszyn, Anal. Chem., 1997, 71, 2998;

Z. Mester and J. Pawliszyn, Rapid Commun. Mass Spectrom., 1999, 13, 1999;

Z. Mester, H. Lord and J. Pawliszyn, J. Anal. At. Spectrom., 2000, 15, 595;

Z. Mester, H. Lord and J. Pawliszyn, J. Chromatogr. A, 2000, submitted for publication,

J. Pawliszyn, U.S. Pat. No. 5,496,741, Mar. 5, 1996;

J. Pawliszyn et al., PCT Publication WO 99/63335, Dec. 9, 1999;

J. Villettaz et al., PCT Publication WO 99/26063, May 27, 1999; and,

K. Rasmussen et al., PCT Publication WO 97/25606, Jul. 17, 1997,

which are incorporated herein by reference.

A powerful tool for trace element speciation is an inductively coupled plasma mass spectrometer (ICP-MS). The ICP-MS has become an ideal instrument for the speciation of organometallic compounds in complex environmental samples, which require the high sensitivity and specificity detection provided by the ICP-MS. Recently, the ICP-MS has been combined with capillary GC for introducing the analyte to the ICP-MS, which is disclosed in the following references:

H. Hintelman, R. D. Evans and J. Y. Villeneuve, J. Anal At. Spectrom., 1995, 9, 619;

T. DeSmaele, P. Verrept, L. Moens and R. Dams, Spectrochim. Acta, Part B, 1995, 11, 1409;

L. Moens, T. DeSmaele, R. Dmas, P. VanDenBroeck and P. Sandra, Anal. Chem., 1997, 69, 1604;

N. S. Chong and R. S. Houk, Appl. Spectrosc., 1987, 41, 66;

G. R. Peters and D. Beauchemin, J. Anal. At. Spectrom., 1992, 7, 965;

W. Kim, M. E. Foulkes, L. Ebdon, S. J. Hill, R. L. Patience, A. G. Barwise and S. J. Rowland, J. Anal. At. Spectrom., 1992, 7, 1147;

W. J. Pretorius, L. Ebdon and S. J. Rowland, J. Chromatogr., 1993, 646, 369;

T. DeSmaele, L. Moens, R. Dams, P. Sandra, J. Vandereycken and J. Vandyck, J. Chromatogr. A, 1998, 793, 99;

S. M. Gallus and K. G. Heumann, J. Anal. At Spectrom., 1996, 11, 887;

J. Poehlman, B. W. Pack and G. M. Hieftje, Am. Lab., 1998, 30, C50; and,

M. M. Bayón, M. G. Camblor, J. I. G. Alonso and A. Sanz-Medel, J. Anal. At. Spectrom., 1999, 14, 1317,

which are incorporated herein by reference.

However, this method needs to couple a relatively bulky and expensive device—GC—to the ICP-MS. Furthermore, this coupling is not straightforward. There are several limitations, probably the most important one being that the analytes have to be maintained in gaseous form during transport from the GC to the ICP-MS, avoiding any condensation effect at the interface. Apart from this fact, the effluent from the GC requires an aerosol carrier gas to achieve sufficient flow to get the analytes into the central channel of the plasma. Numerous problems still remain to be solved in the development of appropriate interfaces able to provide reliable and reproducible results to carry out trace element speciation in environmental samples.

It is, therefore, an object of the invention to overcome the drawbacks of the prior art by directly coupling SPME with ICP-MS.

It is further an object of the invention to provide a simple thermal desorption gas introduction interface for sample introduction of volatile analytes into an atomic spectroscopic detector.

It is another object of the invention to provide an interface of compact design for direct placement at the base of the plasma torch.

### SUMMARY OF THE INVENTION

Fundamental to a system for combining SPME with an atomic spectroscopic detector is the development of an effective method and device for introducing an analyte sampled with the SPME into the atomic spectroscopic detector. The interface between the SPME and the atomic spectroscopic detector such as an ICP-MS serves a dual function—liberating the analyte from the extraction phase of the SPME through a desorption process and transferring the desorbed analyte to the ICP-MS. Reliable and reproducible measurements require a rapid desorption process and a highly efficient transfer of the analyte to the atomic spectroscopic detector without substantial loss of analyte.

In accordance with the present invention there is provided a method for introducing a volatile analyte into an atomic spectroscopic detector comprising the steps of:

providing an injector connected to the atomic spectroscopic detector via a first port, the injector comprising a sealed second port for inserting the volatile analyte bound to an extraction phase;

providing a heating block surrounding the injector;

heating the injector to a predetermined temperature using the heating block, wherein the injector is kept substantially at the predetermined temperature after the same is reached;

providing a carrier gas flow of inert gas into the injector through a third port of the injector, the third port being located in proximity to the second port;

providing an auxiliary gas flow of inert gas between the third port and the atomic spectroscopic detector;

inserting the volatile analyte into the injector, wherein the volatile analyte is bound to an extraction phase, and wherein the extraction phase is inserted through the seal of the second port for sealed exposure of the extraction phase within the injector;

exposing the extraction phase of the fiber;

rapidly thermally desorbing the volatile analyte from the extraction phase through application of the heat and provision of the carrier gas flow;

transporting the volatile analyte to the atomic spectroscopic detector in a gas flow comprising the carrier gas flow and the auxiliary gas flow; and,

retracting the extraction phase after a predetermined time interval has elapsed.

In accordance with the present invention there is further provided a method for introducing a volatile analyte into an atomic spectroscopic detector comprising the steps of:

providing an injector connected to the atomic spectroscopic detector, the injector comprising a sealed port for inserting the volatile analyte bound to an extraction phase;

heating the injector to a predetermined temperature;

providing a carrier gas flow of inert gas;

inserting the extraction phase into the injector through the seal for sealed exposure of the extraction phase within the injector;

thermally desorbing the volatile analyte through application of the heat and provision of the carrier gas flow; and,

transporting the volatile analyte to the atomic spectroscopic detector in the carrier gas flow.

In accordance with an aspect of the present invention there is provided a thermal desorption interface for introducing a volatile analyte into an atomic spectroscopic detector comprising:

an injector connected to the atomic spectroscopic detector via a first port, the injector comprising a sealed second port for sealed insertion of the volatile analyte bound to an extraction phase;

a third port interfaced with the injector in proximity of the second port for provision of an inert carrier gas;

a heating block surrounding the injector for heating the injector to a predetermined temperature and keeping the injector substantially at the predetermined temperature after the same is reached, the temperature being sufficient for rapidly thermally desorbing the volatile analyte; and,

a fourth port interfaced between the third port and the atomic spectroscopic detector for provision of an auxiliary gas flow of inert gas.

In accordance with the aspect of the present invention there is further provided a thermal desorption interface for introducing a volatile analyte into an atomic spectroscopic detector comprising:

an injector connected to the atomic spectroscopic detector via a first port, the injector comprising a sealed second port for sealed insertion of the volatile analyte bound to an extraction phase;

a third port interfaced with the injector in proximity of the second port for provision of an inert carrier gas; and,

a heating mechanism surrounding the injector for heating the injector to a predetermined temperature and keeping the injector substantially at the predetermined temperature after the same is reached, the temperature being sufficient for rapidly thermally desorbing the volatile analyte.

In accordance with another aspect of the present invention there is further provided a thermal desorption interface for introducing a volatile analyte into an atomic spectroscopic detector comprising:

a plurality of measurement units movably attached to a transport mechanism for consecutively moving the plurality of measurement units into a fitted position with respect to the atomic spectroscopic detector and for removing the same from the fitted position into another position, each measurement unit comprising:

an injector comprising:

a first port for connecting to the atomic spectroscopic detector;

a sealed second port for sealed insertion of the volatile analyte bound to an extraction phase;

a third port in proximity of the second port for provision of an inert carrier gas; and,

a fourth port interposed between the third port and the first port for provision of an auxiliary gas flow of inert gas;

a heating block surrounding the injector for heating the injector to a predetermined temperature and keeping the injector substantially at the predetermined temperature after the same is reached, the temperature being sufficient for rapidly thermally desorbing the volatile analyte;

a holding mechanism for holding a SPME unit, for moving the same in a linear fashion and for moving a plunger of the SPME unit;

a first conduit being interfaced with the third port of the injector of a measurement unit if the measurement unit is in the fitted position for provision of the carrier gas; and,

a second conduit being interfaced with the fourth port of the injector of a measurement unit if the measurement unit is in the fitted position for provision of the auxiliary gas flow.

### BRIEF DESCRIPTION OF THE FIGURES

Exemplary embodiments of the invention will now be described in conjunction with the following drawings, in which:

FIG. 1 is a simplified block diagram of a SPME unit according to the prior art;

FIG. 2a is a simplified block diagram of a thermal desorption interface according to the invention;

FIG. 2b is a simplified flow diagram of a method for introducing a volatile analyte into an atomic spectroscopic detector according to the invention;

FIG. 2c is a simplified block diagram of an embodiment of a thermal desorption interface according to the invention;

FIG. 3 is a simplified diagram illustrating the influence of the auxiliary gas flow on the measurement;

FIG. 4 is a simplified diagram illustrating a measurement signal of an ICP-MS using the interface according to the invention;

FIG. 5 is a simplified block diagram of an embodiment of a thermal desorption interface according to the invention;

FIG. 6 is a simplified block diagram of another embodiment of a thermal desorption interface according to the invention;

FIG. 7 is a simplified block diagram of yet another embodiment of a thermal desorption interface according to the invention; and,

FIG. 8 is a simplified block diagram of a further embodiment of a thermal desorption interface according to the invention.

### DETAILED DESCRIPTION OF PREFERRED EMBODIMENTS

In the following, the invention will be described for sample introduction of volatile analytes—in particular volatile metal species—into an ICP-MS, wherein the analyte is sampled using a SPME sampling process. However, it will become evident to persons of skill in the art that the invention is not limited thereto but is applicable for introduction of volatile or semi-volatile analytes sampled using any existing or future sampling process based on absorption or adsorption of an analyte. Furthermore, the invention is applicable for introduction of an analyte into any atomic or organic mass spectroscopic detector.

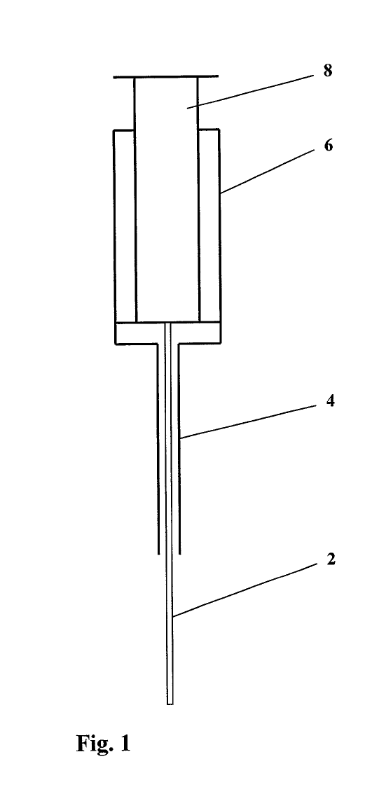

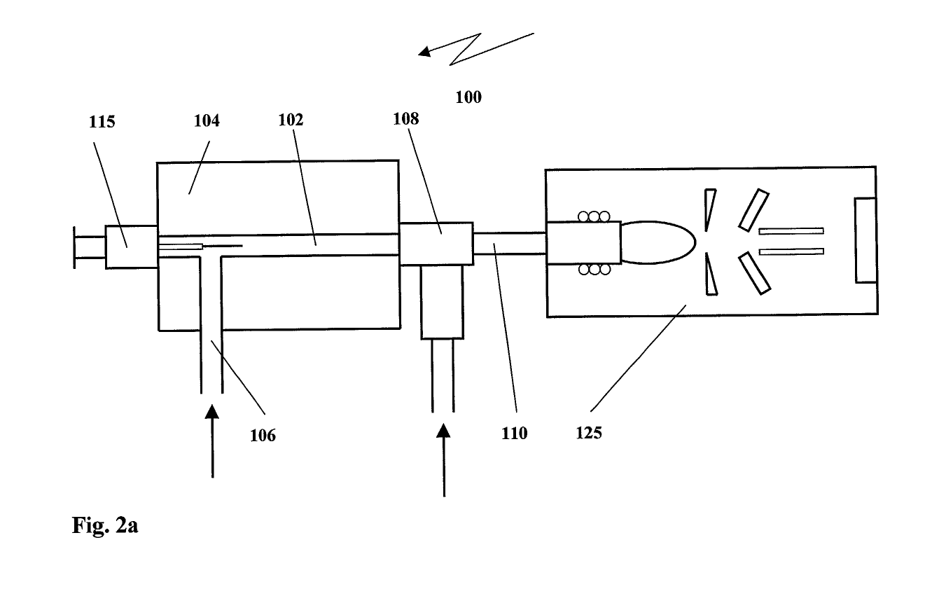

Traditional sample preparation methods are typically time consuming, employ multi-step procedures having high risk for loss of analytes and use extensive amounts of organic solvents. These characteristics make such methods very difficult to automate and integrate into modern sampling/separation systems. As a consequence, most of the analysis time is consumed by sampling and sample preparation. Extensive use of organic solvents in analytical laboratories is no longer tolerated because of the associated health risks and disposal concerns. The SPME process overcomes these drawbacks. In the SPME process the analyte is attached to the extraction phase deposited on a fiber either through adsorption or absorption. SPME is used in liquid or gaseous matrices and primarily aims for partial or equilibrium extraction of the analyte. The principal approach of SPME is the use of a small volume of extraction phase, usually less than 1 μl. The extraction phase is a high molecular weight polymeric “liquid” or a solid sorbent, typically a high surface area porous material. FIG. 1 illustrates schematically the basic structure of a commercially available SPME unit. A small diameter fused-silica fiber 2, coated with the extraction phase is mounted in a syringe-like device 6 for protection and ease of handling. The needle 4 serves to conveniently pierce septa during sample extraction and desorption operations. Using a plunger 8 of the syringe-like device 6 the fiber is extruded from the needle to expose the extraction phase to the sample. After the sampling period the same mechanism is used to retract the fiber inside the needle. During the extraction and desorption periods the fiber is exposed by being outside the needle, during transfer of the SPME unit to a desorption apparatus, the fiber end with the extraction phase is inside the needle for protection.

Fundamental to a system combining SPME with an atomic spectroscopic detector is the development of an effective method and device for introducing an analyte sampled with the SPME into the atomic spectroscopic detector. The interface between the SPME and the atomic spectroscopic detector such as an ICP-MS serves a dual function. First, the analyte is liberated from the extraction phase of the SPME through a desorption process. Second, the desorbed analyte is then transferred to the ICP-MS. For reliable and reproducible measurements it is preferable that the desorption process is rapid and the transfer highly efficient without substantial loss of analyte.

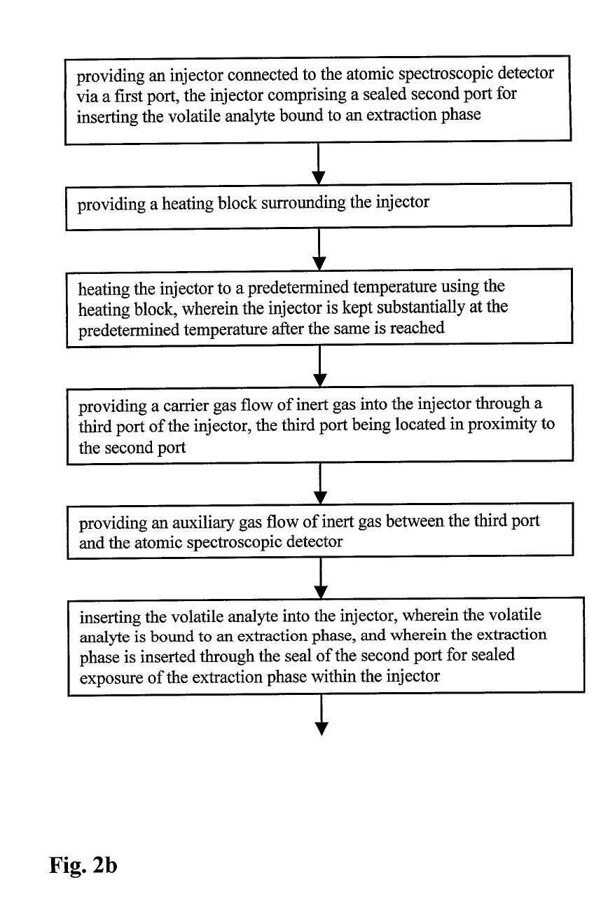

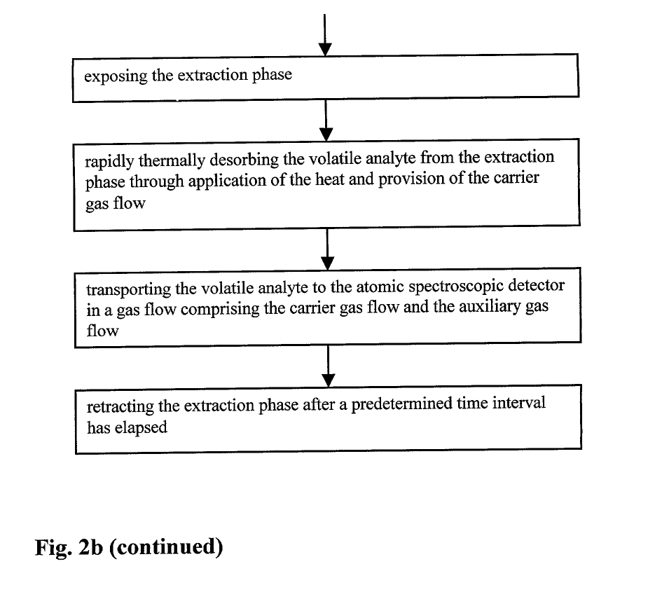

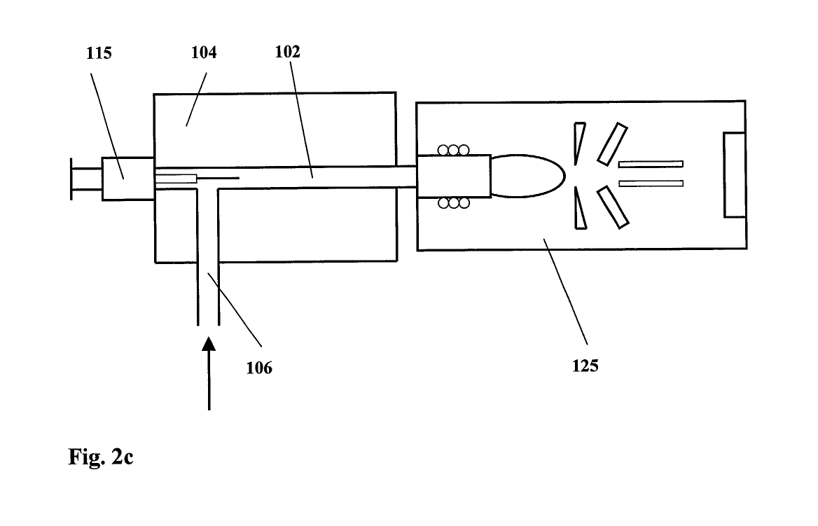

Referring to FIGS. 2a and 2b, a thermal desorption interface 100 and a desorption method according to the invention is shown. The thermal desorption interface 100 comprises an injector 102 such as a sealed glass-lined splitless GC injector for interfacing a SPME unit 115. For example, the injector 102 is sealed with a septum, which is penetrated by needle 4 of the SPME unit for inserting fiber 2 into the injector 102. Sealing of the injector 102 is necessary in order to prevent ambient air from entering the injector during the desorption process. The injector 102 is placed in a heated block 104 and connected to the base of the ICP torch of an ICP-MS 125 via a Swagelok “T” 108 and a transfer line 110 comprising, for example, Teflon tubing. The inner diameter of the injector 102 and the transfer line 110 is approximately 2 mm. A volatile analyte contained in the exposed extraction phase of the fiber of the SPME unit 115 is thermally desorbed into a carrier stream of an inert gas such as Ar, entering the injector 102 through conduit 106 and flowing into the ICP-MS. Optionally, the carrier gas is heated prior to entering the injector 102 to increase the speed of the desorption process. Preferably, the conduit 106 is connected to the injector at a location of the exposed extraction phase of the fiber close to the needle of the SPME unit 115 or at a location of the needle for optimum desorption. The heated block 104 comprises, for example, an electrically heated Al block. Preferably, the heated block 104 comprises a thermal insulation for reducing heat loss and has a sufficient size in order to keep temperature variations of the device during operation at a minimum. Of course, there are numerous other methods for heating the injector as is obvious to a person of skill in the art. The heating block 104 provides enough heat to keep the injector 102 at a temperature high enough for rapidly releasing the analyte—typically between 200° C. and 250° C.—and for heating the injector 102. Heating of the injector 102 minimizes condensation of the analyte and reduces interaction of the analyte with the wall of the injector 102 and the transfer line 110 in order to minimize sample loss that is otherwise severe with analytes such as, for example, methyl mercury. Optionally, the transfer line 110 is heated separately. An auxiliary inert gas such as Ar is introduced via the Swagelok “T” 108 placed between the injector 102 and the transfer line 110 to accommodate a gas flow needed for efficient transfer of analyte from the fiber to the plasma and subsequent sampling into the mass spectrometer 125. Preferably, a same inert gas is used for the carrier gas and the auxiliary gas.

The carrier gas is heated using a separate heating device—not shown—prior entering conduit 106. Preferably, the temperature of the carrier gas does not exceed the temperature of the injector 102.

In an alternative embodiment of the thermal desorption interface 100 the carrier gas is heated through the heating block 104 while passing through conduit 106, wherein the conduit 106 has a sufficient length for heating the carrier gas to a predetermined temperature.

Optionally, also the auxiliary gas is heated in order to prevent condensation of the analyte in the transfer line 110. Further optionally, the transfer line 110 is omitted by directly connecting the Swagelok “T” to the ICP-MS reducing the transfer length of the analyte.

Further optionally, the injector 102 is connected directly to the ICP-MS omitting the Swagelok “T” and the transfer line 110, as shown in FIG. 2c. By substantially reducing the distance between the exposed fiber and the ICP-MS to a minimum it is possible to transfer the analyte without provision of an auxiliary gas flow resulting in a simpler interface compared to the device shown in FIG. 2a. However, this is not a preferred embodiment because the omission of the auxiliary gas flow substantially reduces the ability to adjust the gas flow into the ICP-MS.

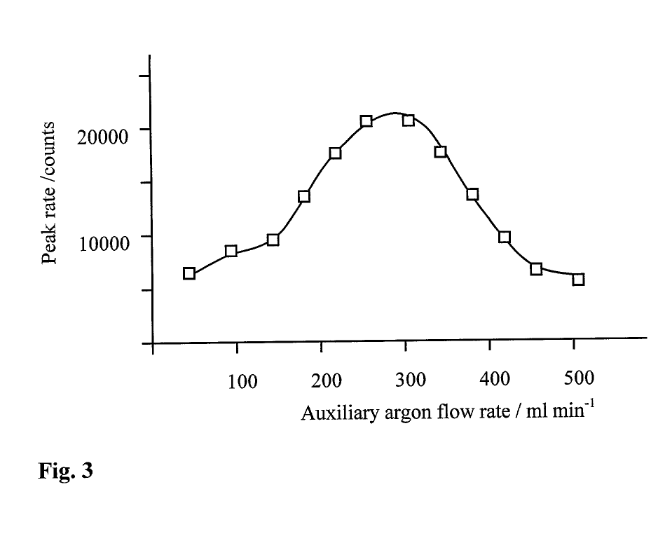

Variation in the auxiliary gas flow rate effectively alters the sampling depth in the plasma. The optimum position is reflecting a balance between atomization-ionization processes and subsequent dispersion/neutralization of the analyte. As illustrated in FIG. 3, the effect of the auxiliary gas flow shows an optimum.

In a preferred mode of operation the septum sealed injector 102 and the transfer line 110 are first flushed with an inert gas, preferably the carrier gas, in order to provide contaminant free conditions for reproducible measurements. The injector 102 is heated to a predetermined temperature while being flushed with inert gas. Provision of the inert gas and heating of the injector 102 substantially removes surface contaminants attached to the wall of the injector 102, for example, air molecules adsorbed at the surface. After reaching the predetermined temperature, the SPME fiber 2 is inserted through the septum seal while being still protected by the needle 4. Using the plunger 8 the extraction-phased portion of the fiber 2 is then exposed for a predetermined time interval and is then withdrawn after elapse of the time interval. The desorption temperature of the injector 102, the exposure time of the fiber 2 and the temperature and the flow rate of the carrier gas as well as the selection of the carrier gas depend on the sampled analyte, the amount of analyte and the type of extraction phase used. Generally, this involves a calibration process, which is performed preferably using the same fiber, which is then also used for the measurements.

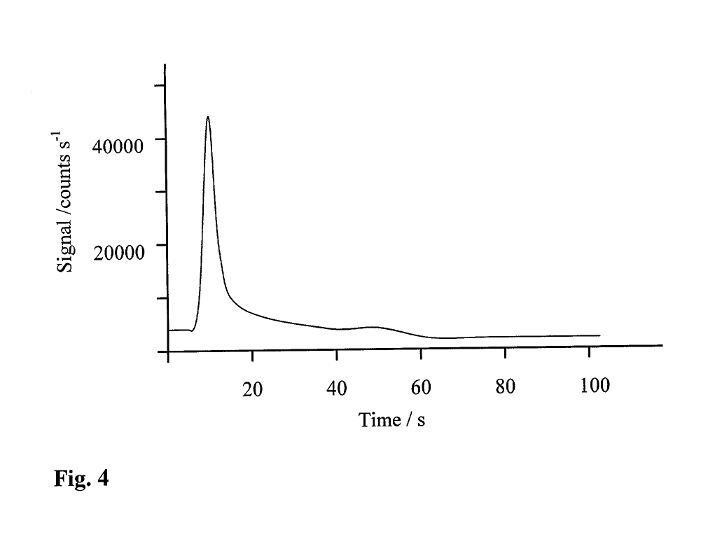

For example, an applied desorption temperature of 250° C. resulted in a rapid release (3-4 s transient peak width) for methyl mercury, as shown in FIG. 4. An exposure time of 40 s resulted in a complete clean up of the fiber for samples in a ng ml⁻¹ concentration range, i. e. all the analyte has been desorbed. This allows reuse of the fiber without additional clean up steps. A carrier gas—Ar—flow rate of 35 ml/min and an auxiliary gas—Ar—flow rate of 280 ml/min were provided. Test data generated using the device and method according to the invention indicate good agreement with certified values. In particular, the relative standard deviation is small due to the very simple and reproducible sample handling procedures involved. Furthermore, tests have shown that the introduction of analytes using the thermal desorption interface according to the invention resulted in measurement data having a very low associated background or noise, as shown in FIG. 4.

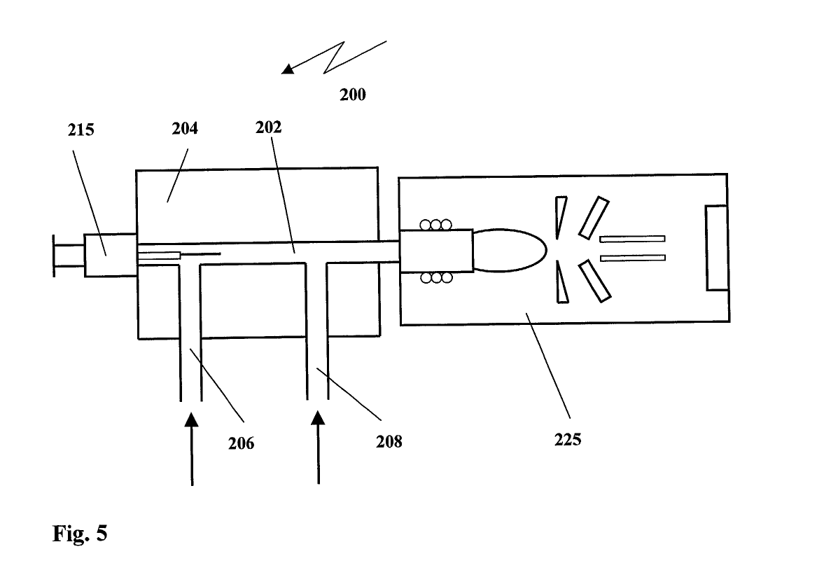

Referring to FIG. 5 another embodiment of a thermal desorption interface 200 according to the invention is shown. Here, the wall of injector 202 has two openings for interfacing conduits 206 and 208 for provision of the carrier gas and the auxiliary gas flow. Furthermore, the injector is directly connected to the ICP-MS 225. Preferably, the injector 202 is a sealed glass-lined splitless injector fitted snugly into a cylindrical opening of heating block 204. This allows easy removal of the injector 202 after use for cleaning or disposal. For example, the interface 200 is affixed to the ICP-MS 225. In preparation of a measurement a sealed injector 202 is inserted into the heating block 204. After the measurement the used injector 202 is removed and replaced with a new or cleaned and sealed injector 202. Therefore, preparation time is substantially reduced allowing a more efficient use of the ICP-MS 225 and the interface 200. Optionally, the carrier gas is heated using heating block 204 or an external heating device. Further optionally, the auxiliary gas is heated too. As is obvious to a person of skill in the art, there are numerous materials for producing the injector. Preferably, a material is selected that has relatively good heat conductivity and has substantially no interaction with the analyte.

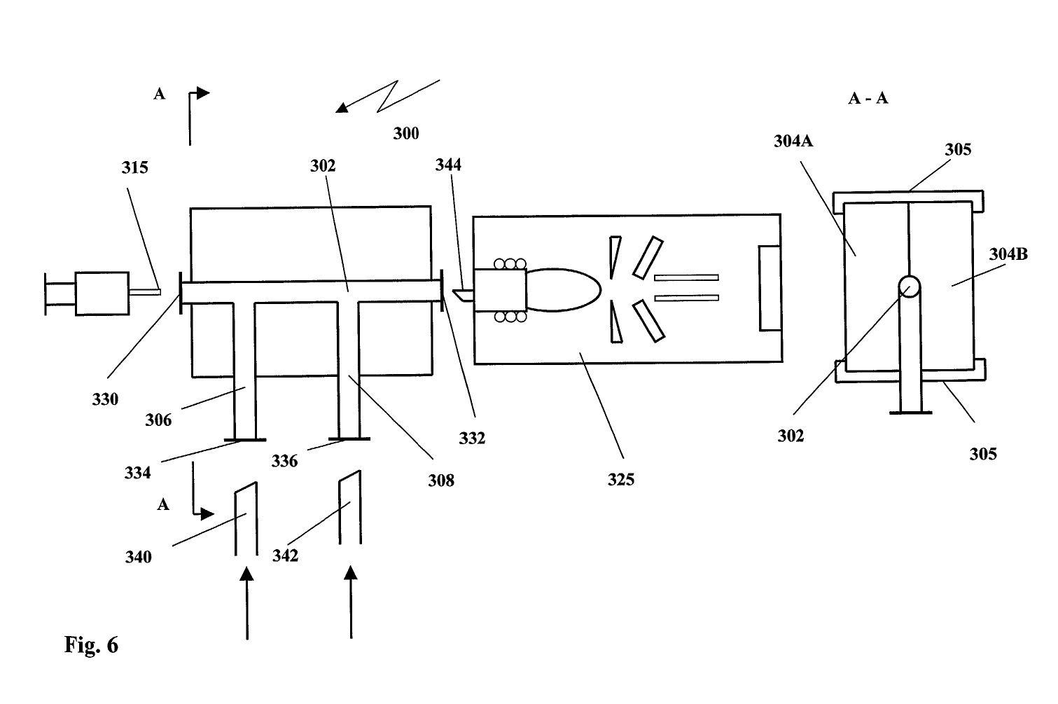

Referring to FIG. 6, a variation 300 of the thermal desorption interface 200 according to the invention is shown. Injector 302 of the thermal desorption interface 300 comprises conduit 306 for provision of the carrier gas and conduit 308 for provision of the auxiliary gas in one unit. All ports 330, 332, 334, and 336 of the injector 302 are sealed. A manufacturer fills the injector 302 to a predetermined pressure with an inert gas such as Ar. In operation the injector 302 is interposed between two heater block portions 304 A and 304 B held together by, for example, a clamping mechanism 305. Then needle like conduits 340, 342 and 344 are inserted through the seals of the ports 334, 336, and 332, respectively, and the interface 300 is ready for operation as disclosed above but without the steps of removing contaminants. In order to allow continuous operation of the ICP-MS a continuous gas supply, not shown in FIG. 6, is provided to the ICP-MS during installation or removal of the injector, as is evident to a person of skill in the art. Using the sealed and pre-filled injector 302 ensures reliable and reproducible measurements by substantially reducing the risk of having contaminants attached to the walls of the injector and the conduits. After use the injector 302 is disposed of and, preferably, recycled by the manufacturer. This allows very quick and efficient preparation of measurements and leads the way to automation.

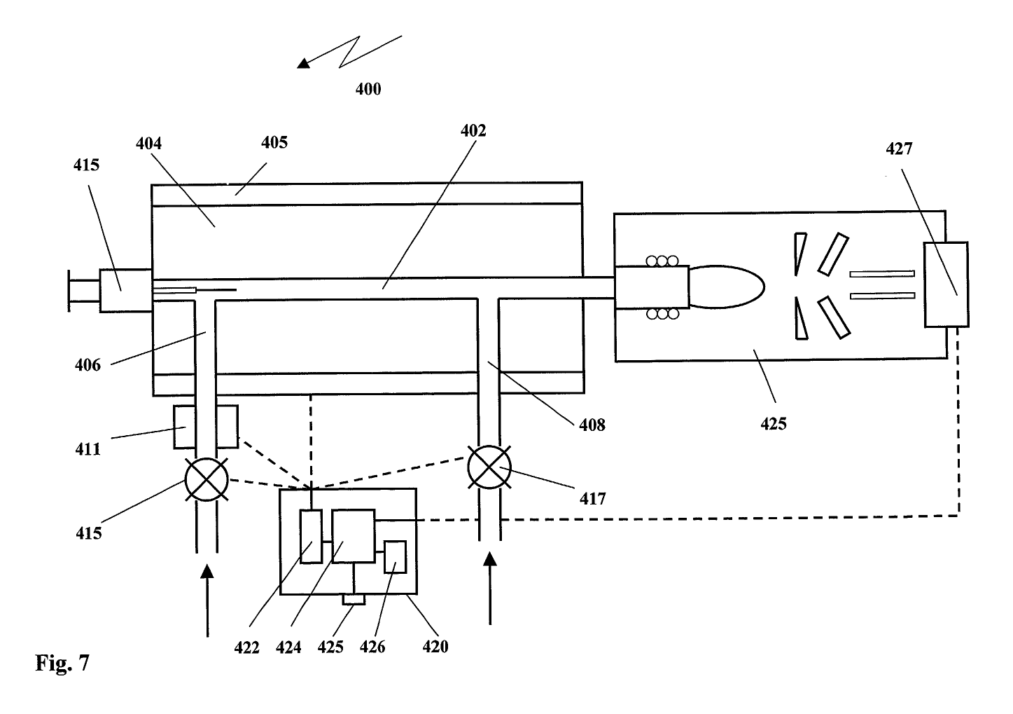

Referring to FIG. 7, another embodiment of a thermal desorption interface 400 according to the invention is shown. In order to provide means for automation of the measurements the thermal desorption interface 400 comprises a digital signal processing unit 420. A processor 424 is connected via a D/A and A/D converter 422 to heating elements 405 and 411, respectively, for controlling heating of the heating block 404 and the carrier gas. Furthermore, the processor 424 is connected via converter 422 to valves 415 and 417 for controlling the carrier gas flow and the auxiliary gas flow, respectively.

Optionally, temperature sensors and flow rate measurement sensors are disposed for measuring heating block temperature, carrier gas temperature, carrier gas flow rate and auxiliary gas flow rate and for providing a feed back to the processor 424. This provides automated operation of the desorption interface according to predetermined values provided through digital port 425 and, preferably stored in memory 426. For example, data for defining the above mentioned parameters are stored in the memory 426 for measurements of different analytes. An operator of the interface 400 has then only to select the analyte to be investigated and the processor 424 regulates the interface 400 automatically without interference of the operator.

Further optionally, the processor 424 is connected to a detection unit 427 of the ICP-MS, for supporting calibration processes based on measurement data—transient signals—provided by the ICP-MS. For example, this embodiment allows optimization of the gas flow rates of the carrier gas and the auxiliary gas as well as the temperatures of the heating block and the carrier gas based on the measured profiles—transient peak width and counts per second of the transient signals.

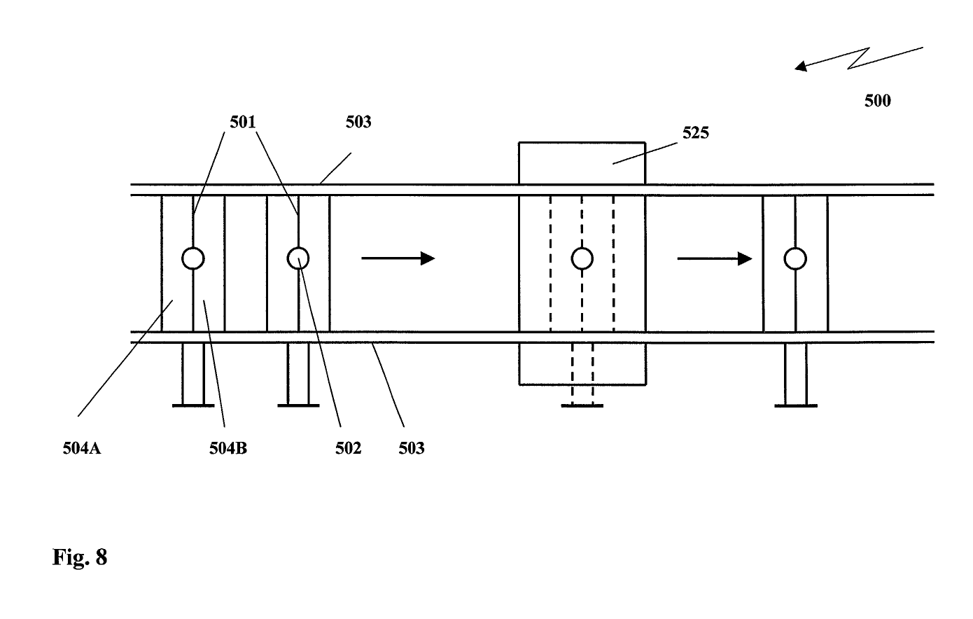

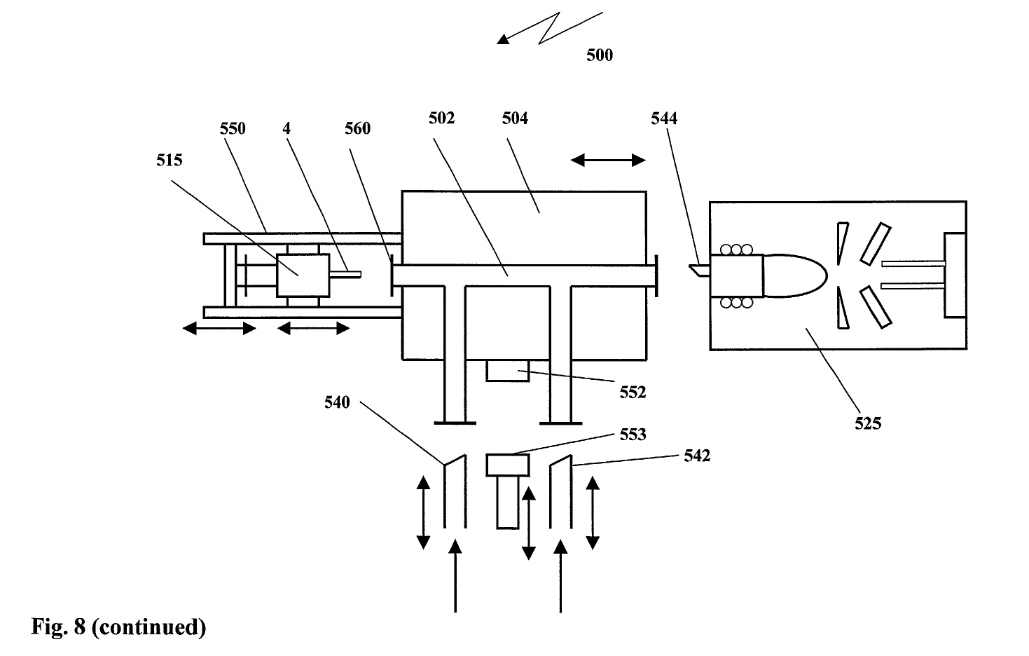

The next step of automation is achieved in the embodiment of a thermal desorption interface 500 shown in FIG. 8. Here, a plurality of measurement units 501 is movably attached to a transportation mechanism 503. Each measurement unit 501 comprises two heater block portions 504A and 504B having an injector 502 interposed therebetween. Furthermore, the measurement unit 501 comprises holding mechanism 550 attached to one or to both heater block portions for moving a SPME unit 515 in a linear fashion and for moving the fiber 2 of the SPME unit 515 by linearly moving plunger 8.

In operation, a measurement unit 501 is positioned at a predetermined location with respect to ICP-MS 525 using the transportation mechanism 503. The measurement unit is then moved towards the ICP-MS 525 until conduit 544 is inserted into the injector at a predetermined position. Conduits 540 and 542 for provision of carrier gas and auxiliary gas are then connected as well as port 552 with connector 553 for provision of electrical power for heating the heating block 504 and, optionally, providing sensed temperature data to a processor—not shown. Optionally conduits 540 and 542 and connector 553 are enclosed in one unit and moved as one unit as well. In the following step the SPME unit 515 is moved until needle 4 of the SPME unit 515 is inserted into the injector 502 through seal 560 and the tip of the needle is located at a predetermined position within the injector 502. Moving the plunger 8 in a linear fashion towards the injector 502 exposes the extraction phase of fiber 2. After predetermined time interval for exposing the fiber 2 is elapsed the fiber 2 is retracted. Then, optionally, the SPME unit 515 is retracted. In the following step conduits 540 and 542 as well as connector 553 are retracted, followed by the retraction of the measurement unit 501 from conduit 544. The measurement unit 501 is then free for moving to a parking position for, for example, removal by an operator. The injector 502 is connected to conduits 540, 542 and 544 by sealed connectors. Alternatively, injector 502 is filled with an inert gas by a manufacturer and sealed as shown in FIG. 8. The seals are then penetrated by needle like conduits. It is evident to a person of skill in the art that commercially available microprocessor technology allows to program all the functions illustrated above for fully automated operation of the thermal desorption interface according to the invention.

Optionally, the injector is stationary and only the SPME units are movably attached to a transportation mechanism via a holding mechanism. In operation, the SPME unit is positioned at a predetermined location with respect to the injector. Using the holding mechanism the SPME unit is moved until the needle of the SPME unit is inserted into the injector through the seal and the tip of the needle is located at a predetermined position within the injector. Moving the plunger in a linear fashion towards the injector exposes then the extraction phase of the fiber.

The thermal desorption interface 500 is highly advantageous for automating measurements. For example, one operator prepares a plurality of measurement units 501 and inserts the prepared measurement units 501 into the transportation mechanism while measurements are performed in an automated fashion. After the measurement the measurement units 501 are provided for removal and preparation. This allows continuous use of the ICP-MS. Furthermore, it allows performing of large numbers of measurements which becomes more and more commonplace for monitoring purposes, for example, monitoring of the air quality at workplaces or in the environment.

The direct coupling of the SPME with ICP-MS via the thermal desorption interface according to the invention provides a new approach for both the sampling and sample introduction of volatile analytes into an atomic spectroscopic detector. The compact design of the interface lends itself to direct placement at the base of the torch of an atomic spectroscopic detector, significantly minimizing the length of the transfer zone, which is particularly important for very reactive analytes such as, for example, methylmercury. Furthermore, this technique is applicable for the introduction of analytes into any atomic spectroscopic detector as well as organic mass spectroscopic detectors. This interface design also offers the possibility for direct introduction of small amounts of a sampling phase such as an organic solvent containing volatile analytes into the plasma by evaporating the sampling phase and the analyte which are then transported in a carrier gas flow. For example, this possibility allows use of liquid-liquid extraction techniques for sampling. Particularly attractive is the significant preconcentration factor arising from application of the thermal desorption interface with SPME. The combination of the sensitive ICP-MS detection with the high efficiency of the sampling and sample introduction system also offers a new approach to the passive sampling of volatile metals in different environments, for example, use in exposure studies.

Numerous other embodiments of the invention will be apparent to persons skilled in the art without departing from the spirit and scope of the invention as defined in the appended claims.

What is claimed is:

1. A method for introducing a volatile analyte into an atomic spectroscopic detector comprising the steps of:
providing an injector connected to the atomic spectroscopic detector;
heating the injector to a predetermined temperature, wherein the injector is kept substantially at the predetermined temperature after the same is reached;
providing a carrier gas flow of inert gas into the injector;
providing an auxiliary gas flow of inert gas;
inserting the volatile analyte into the injector, wherein the volatile analyte is bound to an extraction phase, and wherein the extraction phase is inserted through a seal for sealed exposure of the extraction phase within the injector;
exposing the extraction phase;
rapidly thermally desorbing the volatile analyte from the extraction phase through application of the heat and provision of the carrier gas flow; and,
transporting the volatile analyte to the atomic spectroscopic detector in a gas flow comprising the carrier gas flow and the auxiliary gas flow.

2. A method for introducing a volatile analyte into an atomic spectroscopic detector as defined in claim 1, comprising the step of retracting the extraction phase after a predetermined time interval has elapsed.

3. A method for introducing a volatile analyte into an atomic spectroscopic detector as defined in claim 2, wherein the volatile analyte is bound to an extraction phase attached to a portion of a fiber, the fiber being movably disposed within a needle.

4. A method for introducing a volatile analyte into an atomic spectroscopic detector as defined in claim 3, wherein the volatile analyte is inserted by penetrating the seal with the needle and by moving the fiber for exposing the portion of the fiber comprising the extraction phase.

5. A method for introducing a volatile analyte into an atomic spectroscopic detector as defined in claim 4, wherein the volatile analyte has been sampled using a SPME unit comprising the needle and the fiber.

6. A method for introducing a volatile analyte into an atomic spectroscopic detector as defined in claim 4, flushing the injector with inert gas for removing contaminants.

7. A method for introducing a volatile analyte into an atomic spectroscopic detector as defined in claim 4, wherein the carrier gas and the auxiliary gas are a same gas.

8. A method for introducing a volatile analyte into an atomic spectroscopic detector as defined in claim 7, wherein the gas is argon.

9. A method for introducing a volatile analyte into an atomic spectroscopic detector as defined in claim 7, wherein the volume of the extraction phase is less than 1 μl.

10. A method for introducing a volatile analyte into an atomic spectroscopic detector as defined in claim 9, wherein the extraction phase is a high molecular weight polymeric liquid sorbent.

11. A method for introducing a volatile analyte into an atomic spectroscopic detector as defined in claim 9, wherein the extraction phase is a solid sorbent.

12. A method for introducing a volatile analyte into an atomic spectroscopic detector as defined in claim 9, wherein the predetermined temperature is a temperature between 200° C. and 250° C.

13. A method for introducing a volatile analyte into an atomic spectroscopic detector as defined in claim 12, wherein all of the volatile analyte has been desorbed during the predetermined time interval.

14. A method for introducing a volatile analyte into an atomic spectroscopic detector as defined in claim 12, wherein the volatile analyte is a volatile metal species.

15. A method for introducing a volatile analyte into an atomic spectroscopic detector as defined in claim 12, wherein the carrier gas is heated.

16. A method for introducing a volatile analyte into an atomic spectroscopic detector as defined in claim 15, wherein the temperature of the heated carrier gas does not exceed the predetermined temperature.

17. A method for introducing a volatile analyte into an atomic spectroscopic detector as defined in claim 14, wherein the atomic spectroscopic detector is an ICP-MS.

18. A method for introducing a volatile analyte into an atomic spectroscopic detector as defined in claim 17, wherein the auxiliary gas flow is optimized with respect to a sampling depth of the plasma of the ICP-MS.

19. A method for introducing a volatile analyte into a spectroscopic detector comprising the steps of:
providing an injector connected to the spectroscopic detector;
heating the injector to a predetermined temperature;
providing a carrier gas flow of inert gas;
inserting the volatile analyte into the injector, wherein the volatile analyte is contained in a sampling phase, and wherein the sampling phase is inserted through a seal for sealed exposure of the sampling phase within the injector;
thermally evaporating the volatile analyte through application of the heat and provision of the carrier gas flow; and,
transporting the volatile analyte to the spectroscopic detector in the carrier gas flow.

20. A method for introducing a volatile analyte into a spectroscopic detector as defined in claim 19, wherein the spectroscopic detector comprises an organic mass spectroscopic detector.

21. A method for introducing a volatile analyte into a spectroscopic detector as defined in claim 19, wherein sampling phase comprises an organic solvent.

22. A method for introducing a volatile analyte into a spectroscopic detector as defined in claim 19, wherein sampling phase comprises a liquid extraction phase.

23. A thermal desorption interface for introducing a volatile analyte into an atomic spectroscopic detector comprising:
an injector connected to the atomic spectroscopic detector via a first port, the injector comprising a sealed second port for sealed insertion of the volatile analyte bound to an extraction phase;
a third port interfaced with the injector in proximity of the second port for provision of an inert carrier gas;
a heating block surrounding the injector for heating the injector to a predetermined temperature and keeping the injector substantially at the predetermined temperature after the same is reached, the temperature being sufficient for rapidly thermally desorbing the volatile analyte; and,
a fourth port interfaced between the third port and the atomic spectroscopic detector for provision of an auxiliary gas flow of inert gas.

24. A thermal desorption interface for introducing a volatile analyte into an atomic spectroscopic detector as defined in claim 23, wherein the third port is interfaced with the injector such that at least a portion of the extraction phase is located between the third port and the first port.

25. A thermal desorption interface for introducing a volatile analyte into an atomic spectroscopic detector as defined in claim 24, wherein the injector comprises a sealed glass-lined splitless GC injector.

26. A thermal desorption interface for introducing a volatile analyte into an atomic spectroscopic detector as defined in claim 25, wherein the seal comprises a septum.

27. A thermal desorption interface for introducing a volatile analyte into an atomic spectroscopic detector as defined in claim 26, wherein the fourth port comprises a Swagelok “T” interfaced with the first port.

28. A thermal desorption interface for introducing a volatile analyte into an atomic spectroscopic detector as defined in claim 27, comprising a transfer line interposed between the Swagelok “T” and the atomic spectroscopic detector.

29. A thermal desorption interface for introducing a volatile analyte into an atomic spectroscopic detector as defined in claim 28, wherein the transfer line comprises Teflon tubing.

30. A thermal desorption interface for introducing a volatile analyte into an atomic spectroscopic detector as defined in claim 26, wherein the heating block is made of Al.

31. A thermal desorption interface for introducing a volatile analyte into an atomic spectroscopic detector as defined in claim 30, wherein the heating block is electrically heated.

32. A thermal desorption interface for introducing a volatile analyte into an atomic spectroscopic detector as defined in claim 31, comprising a heater for heating the carrier gas.

33. A thermal desorption interface for introducing a volatile analyte into an atomic spectroscopic detector as defined in claim 31, wherein the injector comprises a cylindrical tubing fitted snugly into the heating block.

34. A thermal desorption interface for introducing a volatile analyte into an atomic spectroscopic detector as defined in claim 24, wherein the fourth port is interfaced with the injector and wherein the ports are sealed prior to use.

35. A thermal desorption interface for introducing a volatile analyte into an atomic spectroscopic detector as defined in claim 34, wherein the sealed injector comprises an inert gas.

36. A thermal desorption interface for introducing a volatile analyte into an atomic spectroscopic detector as defined in claim 32, comprising an electrical heating element for heating the heating block.

37. A thermal desorption interface for introducing a volatile analyte into an atomic spectroscopic detector as defined in claim 36, comprising a first valve interfaced with the third port for regulating the flow rate of the carrier gas.

38. A thermal desorption interface for introducing a volatile analyte into an atomic spectroscopic detector as defined in claim 37, comprising a second valve interfaced with the fourth port for regulating the flow rate of the auxiliary gas.

39. A thermal desorption interface for introducing a volatile analyte into an atomic spectroscopic detector as defined in claim 38, comprising a first temperature sensor for sensing the temperature of the injector.

40. A thermal desorption interface for introducing a volatile analyte into an atomic spectroscopic detector as defined in claim 39, comprising a second temperature sensor for sensing the temperature of the carrier gas.

41. A thermal desorption interface for introducing a volatile analyte into an atomic spectroscopic detector as defined in claim 40, comprising a first flow rate sensor for sensing the flow rate of the carrier gas.

42. A thermal desorption interface for introducing a volatile analyte into an atomic spectroscopic detector as defined in claim 41, comprising a second flow rate sensor for sensing the flow rate of the auxiliary gas.

43. A thermal desorption interface for introducing a volatile analyte into an atomic spectroscopic detector as defined in claim 42, comprising a digital processing unit for providing a control function of the heating element, the heater for heating the carrier gas, the first valve and the second valve.

44. A thermal desorption interface for introducing a volatile analyte into an atomic spectroscopic detector as defined in claim 43, wherein the digital processing unit comprises a first port for receiving signals from the first and the second temperature sensor and the first and second flow rate sensor, and wherein the digital processing unit comprises circuitry for processing the received signals and for determining the control function.

45. A thermal desorption interface for introducing a volatile analyte into an atomic spectroscopic detector as defined in claim 44, comprising memory for storing digital data for determining control functions in dependence thereupon.

46. A thermal desorption interface for introducing a volatile analyte into an atomic spectroscopic detector as defined in claim 45, comprising a second port for receiving a measurement signal from the atomic spectroscopic detector.

47. A thermal desorption interface for introducing a volatile analyte into an atomic spectroscopic detector as defined in claim 46, wherein the digital processing unit comprises circuitry for processing the measurement signal and for supporting calibration processes.

48. A thermal desorption interface for introducing a volatile analyte into a spectroscopic detector comprising:
an injector connected to the spectroscopic detector via a first port, the injector comprising a sealed second port for sealed insertion of the volatile analyte bound to an extraction phase;
a third port interfaced with the injector in proximity of the second port for provision of an inert carrier gas; and,
a heating mechanism surrounding the injector for heating the injector to a predetermined temperature and keeping the injector substantially at the predetermined temperature after the same is reached, the temperature being sufficient for rapidly thermally evaporating the volatile analyte.

49. A thermal desorption interface for introducing a volatile analyte into an atomic spectroscopic detector comprising:
a plurality of measurement units movably attached to a transport mechanism for consecutively moving the plurality of measurement units into a fitted position with respect to the atomic spectroscopic detector and for removing the same from the fitted position into another position, each measurement unit comprising:
an injector comprising:
a first port for connecting to the atomic spectroscopic detector;
a sealed second port for sealed insertion of the volatile analyte bound to an extraction phase;
a third port in proximity of the second port for provision of an inert carrier gas; and,
a fourth port interposed between the third port and the first port for provision of an auxiliary gas flow of inert gas;
a heating block surrounding the injector for heating the injector to a predetermined temperature and keeping the injector substantially at the predetermined temperature after the same is reached, the temperature being sufficient for rapidly thermally desorbing the volatile analyte;
a holding mechanism for holding a SPME unit, for moving the same in a linear fashion and for moving a plunger of the SPME unit;
a first conduit being interfaced with the third port of the injector of a measurement unit if the measurement unit is in the fitted position for provision of the carrier gas; and,
a second conduit being interfaced with the fourth port of the injector of a measurement unit if the measurement unit is in the fitted position for provision of the auxiliary gas flow.
